(19) United States
(12) Patent Application Publication
(10) Pub. No.: US 2019/0098883 A1
(43) Pub. Date: Apr. 4, 2019

(54) Multi-Angled Fishing Hook

(71) Applicants: Wen-Fang Carrie Tung, Rockdale NSW (AU); Johannes Georg Meierhofer, Rockdale NSW (AU)

(72) Inventors: Wen-Fang Carrie Tung, Rockdale NSW (AU); Johannes Georg Meierhofer, Rockdale NSW (AU)

(21) Appl. No.: 16/120,220

(22) Filed: Sep. 1, 2018

(30) Foreign Application Priority Data
Oct. 1, 2017 (AU) 2017236036

(51) Int. Cl. A01K 83/04

(52) U.S. Cl. CPC A01K 83/04

(57) ABSTRACT

Disclosed is a multi-angled fishing hook (1) that includes multiple unclosed angles (2) with a plurality of grooves (3) forming into the entire bend (4) of the hook. The multiple unclosed angles include at least 4-6 regular or irregular more than 90 degrees of angles distributed separately along the bend. The plurality of grooves is cut transversely to each straight line of the angles on the bend. The bend of the hook that connects the sharp point (5) to the shank (6) is therefore an obvious regular or irregular multi-angled shape (7). The multi-angled fishing hook is to utilise the compressive force as well as friction that develop from each formed angle with grooves to grip bait more tightly and securely on the bend of the hook so that the movements of bait and caught fish are restricted and unable to fall off or escape easily.

### TECHNICAL FIELD OF THE INVENTION

The present disclosure generally relates to a fishing hook, and more particularly to a multi-angled fishing hook that effectively retains universal baits and caught fish on the bend of the hook during recreational bait-fishing.

### BACKGROUND OF THE INVENTION

A fishing hook has been recognised as the most essential device to hold fishing bait and secure caught fish. There are various types of fishing hooks available for retaining bait and caught fish in the prior art. Despite so many varieties of fishing hooks that claim to be effective on their intended purposes, retaining bait and caught fish on the hook is still the greatest challenge for anglers today as soft bait and caught fish constantly move and then become separated from fishing hooks.

A typical fishing hook generally includes a sharp point, barb, bend, shank and an eye. The bend is the curved portion of the hook in a rounded, oval or U shape that connects the sharp point to the shank of the hook. The function of the bend is supposed to securely hold most part of bait body and the caught fish in the bend section. However a common problem that arises on the hook itself is that the bend of the hook provides too little resistance and tension to grip the bait or fish effectively against their movements and earth gravity which easily provides movability and flexibility to the bait or fish on the hook. Most of the anglers hence mainly rely on the barb of the hook to prevent bait or fish from getting lost, which unfortunately the performance of the barb is still uncertain and unreliable. Accordingly, the presented invention is designed to overcome the foregoing deficiencies of the bend of the hook and maximise its function to grip the bait and fish securely.

### SUMMARY OF THE INVENTION

The present invention provides a multi-angled fishing hook that comprises multiple unclosed angles with a plurality of grooves forming into its entire bend section. The present invention has objects described herein that meet the needs of enhancing the function of the bend of the hook and effectively prevent bait or caught fish from losing.

The primary object of the present invention is to provide a multi-angled fishing hook that has a multi-angled bend with a plurality of grooves on it to develop resistance and grip force in order to enhance the function of the hook bend to its maximum.

An additional object of the present invention is to provide a multi-angled fishing hook that retains universal soft bait and caught fish securely on the bend section of the hook with its multi-angled design as well as grooves across the entire bend.

A further object of the present invention is to provide a multi-angled fishing hook that is simple to be used and can connect the hook to fishing line directly without any other assistive device attached for retaining bait and fish.

A further object of the present invention is to provide a multi-angled fishing hook that has different sizes with various types of multi-angled designs on the bend to suit different soft bait.

### BRIEF DESCRIPTION OF DRAWINGS

FIG. 1 is a side perspective view of the multi-angled fishing hook made of 4 irregular angles with a number of grooves across its entire bend.

FIG. 2 is a side perspective view of the multi-angled fishing hook made of 5 irregular angles with a plurality of grooves across its entire bend.

FIG. 3 is a side perspective view of the multi-angled fishing hook made of 6 regular angles with a plurality of grooves across its entire bend.

### DESCRIPTION OF EMBODIMENTS

The description of embodiments of the present invention provides a multi-angled fishing hook that includes a sharp point, a barb, a straight shank, an eye and multiple unclosed angles with a plurality of grooves forming into the entire bend of the hook. The multiple unclosed angles include at least 4-6 regular or irregular more than 90 degrees of angles distributed separately along the bend that compose of equal or unequal length of straight sides as well as regular or irregular corners to form the entire bend of the hook. The plurality of grooves is cut transversely to each straight line of the angles on the bend, and each straight line comprises at least 2 grooves in the middle section of the line. The entire bend of the hook that connects the sharp point to the shank is therefore an obvious regular or irregular multi-angled shape instead of a typical oval or rounded shape. Each formed angle on the bend provides compressive force to support different part of bait body and restrict the movements of bait or caught fish in where its body part sits on. The plurality of grooves on each straight line also provides friction for bait or caught fish not able to move freely.

The mechanism of the multi-angled fishing hook is to utilise the compressive force as well as friction that develop from each formed angle with grooves to grip bait more tightly and securely on the bend of the hook and construct a serial of tricky obstacles so that the movements of bait and caught fish are restricted and unable to fall off or escape easily. Even the end of bait body attached to the shank gets affected by earth gravity and falls off; the compressive force and friction developed from all angles together are still strong enough to support the weight of the end of bait body sliding down from the shank. Additionally, the compressive force and friction from the combination of different angles provide a function on reconstructing the internal tissue damage of the bait body. The method of using the multi-angled fishing hook is simply the same as using a typical fishing hook. However the multi-angled hook does not only provide a tricky way for bait and caught fish to escape but also provides the same tricky way for anglers to hook their bait through each angle. It requires a bit extra care when penetrating bait through each angle of the bend such as gently and slowly pulling the bait body through. Ideally in the market, the multi-angled hook would be made of 4-6 regular or irregular angles combined with at least 2 grooves on each straight line across the entire bend section to suit different sizes and types' soft bait such as a prawn bait or live worm.

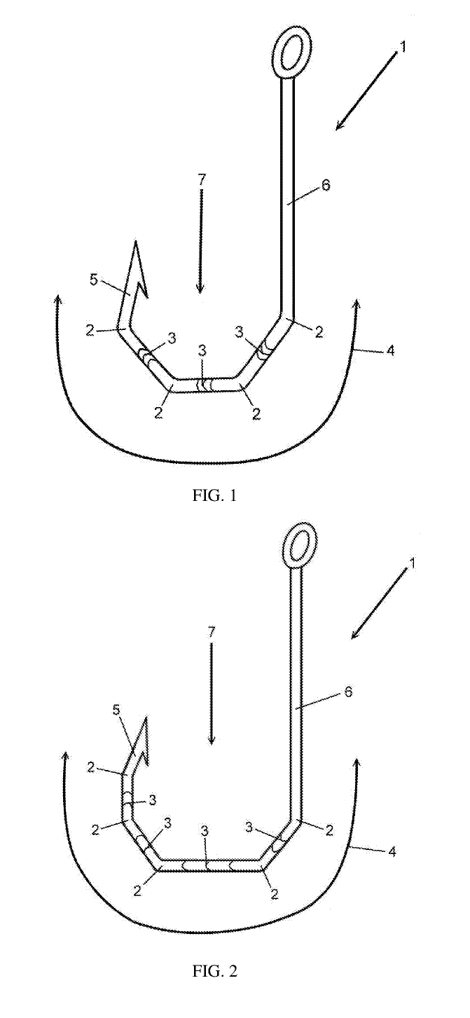

One example on the use of the present invention is to gently attach a prawn bait onto a multi-angled fishing hook as the usual way of using a typical hook. The prawn bait can be attached to the multi-angled hook as shown either in FIG. 1 or FIG. 3 depending on the size of the prawn bait. The angler would experience the resistance and force with his fingers like a tight feeling when pulling the prawn bait through each angle of the bend. After the penetrating process, most weight and body parts of the prawn where it sits on the inner angles are compressed together and supported within the bend area of the hook. This force effectively grips the prawn bait on the hook as it limits the movements of the prawn bait and reduces the tissue damage caused by constant movements on the hook.

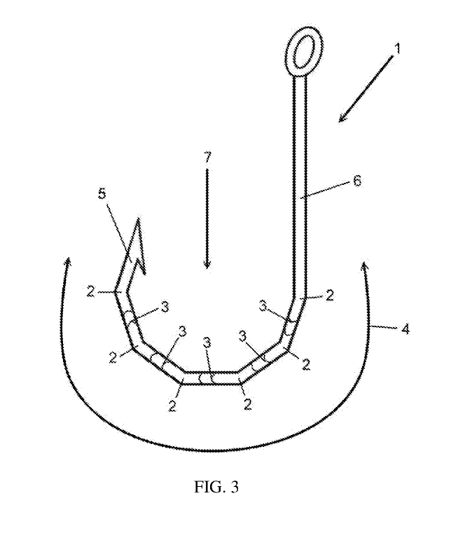

Another example on the use of the present invention is to attach a live blood worm onto a multi-angled fishing hook. The live worm can be attached to the multi-angled fishing hook as shown in either FIG. 2 or FIG. 3. The multi-angled fishing hook shown in FIG. 2 provides a longer length of the straight line down the bottom and the front part of the bend underneath the sharp point has more angles for the live worm not able to escape through the exit easily. The multi-angled fishing hook shown in FIG. 3 provides a more tricky way out due to having more angles across the entire bend. Insert the head of the worm first as usual from the sharp point of the hook, then gently pulling the worm through each angle until most of the worm body are positioned on the multi-angled bend. The live worm can be expected to be still trying to escape by moving up and down on the hook. The multiple angles of the bend are then able to provide resistance and grip force to limit the movements of the live worm and increase difficulty for the live worm to wriggle through each angle of the bend from the hook completely.

Additional example on the use of the present invention is to secure a caught fish on a multi-angled fishing hook until trolling back to the shore. When the fish mouth is hooked up through the sharp point of the hook into the bend, the angles of the bend then restrain the movements of the fish mouth within one to two angles on the bend with their compressive force. The fish is therefore not able to slide its mouth out of the bend area as easy as like on a typical hook, because the angles of the hook bend provide resistance and friction to limit the fish mouth within one to two angles; and the rest of the angles with grooves around the fish mouth immediately become a serial of difficult obstacles for the fish to overcome as the fish needs to slide its mouth higher than normal when escaping through each angle. The fish can be expected to get exhausted quickly and then even harder to escape.

According to the objects, illustrations and examples mentioned above, it can be seen that the present invention is novel and different to the prior art when being used to overcome the challenge of retaining bait or fish during recreational fishing. It also can be seen that the present invention provides a unique multi-angled design on its bend to suit different bait; and enhance the function of the entire bend of the hook on gripping bait or caught fish effectively.

The present invention has been described by ways of specific embodiments, examples, implementations and configurations which are intended to be exemplary or illustrative only. It should be appreciated that other variants, modifications, refinements and applications may be made without departing from the scope of the invention. Accordingly the scope of the exclusive right sought by the applicant for the present invention is intended to be limited solely as defined in the claims.

1. A multi-angled fishing hook comprises:
a sharp point;
a barb;
a straight shank;
an eye; and
multiple unclosed angles with a plurality of grooves forming into the entire bend of the hook.

2. The multi-angled fishing hook recited in claim 1, wherein said
the multiple unclosed angles include at least 4-6 regular or irregular more than 90 degrees of angles distributed separately along the bend that compose of equal or unequal length of straight sides as well as regular or irregular corners to form the entire bend of the hook.

3. The multi-angled fishing hook recited in claim 1, wherein said
the plurality of grooves is cut transversely to each straight line of the angles on the bend and each straight line comprises at least 2 grooves in the middle section of the line.

4. The multi-angled fishing hook recited in claim 1, wherein said
the entire bend of the hook that connects the sharp point to the shank is an obvious regular or irregular multi-angled shape.

5. The multi-angled fishing hook recited in claim 1, wherein said
the multi-angled fishing hook is to utilise the compressive force as well as friction that develop from each formed angle with grooves to grip bait more tightly and securely on the bend of the hook and construct a serial of tricky obstacles so that the movements of bait and caught fish are restricted and unable to fall off or escape easily.

6. The multi-angled fishing hook recited in claim 1, wherein said
the multi-angled fishing hook ideally in the market would be made of 4-6 regular or irregular angles combined with at least 2 grooves on each straight line across the entire bend section to suit different sizes and types' soft bait.
